(19) United States
(12) Patent Application Publication
(10) Pub. No.: US 2009/0022959 A1
(43) Pub. Date: Jan. 22, 2009

(54) Wall Element

(76) Inventor: Wilhelmus Jan Reinier Karel Snel, Zwaag (NL)

Correspondence Address: GORDON & REES LLP, 101 WEST BROADWAY, SUITE 1600, SAN DIEGO, CA, 92101, US

(21) Appl. No.: 12/223,438

(22) PCT Filed: Jan. 16, 2007
(86) PCT No.: PCT/NL2007/050019

§ 371 Date: Aug. 14, 2008

(30) Foreign Application Priority Data
Jan. 30, 2006 (NL) 2000001

(51) Int. Cl. B32B 1/04; B32B 38/00

(52) U.S. Cl. 428/174; 156/210

(57) ABSTRACT

A wall element comprising two outer layers extending at least substantially parallel to each other, between which at least two intermediate layers are provided, wherein each intermediate layer extends between the outer layers in a zigzag fashion, each intermediate layer comprising first parts that extend at least substantially parallel to the outer layers and second parts that extend between adjacent first parts, wherein first parts of one intermediate layer that face towards one outer layer are connected to said one outer layer, and wherein first parts of the other intermediate layer that face towards the other outer layer are connected to said other outer layer, a characteristic feature being the fact that said intermediate layers are identical in shape, with the intermediate layers being connected along their adjoining second parts, and a method of manufacturing the wall element.

### CROSS-REFERENCE TO RELATED APPLICATIONS

This application is a United States national stage entry of PCT application serial number PCT/NL2007/050019 filed Jan. 16, 2007, entitled “Wall Element,” which claims priority to Netherlands patent application serial number NL 2000001 filed Jan. 30, 2006. This application claims the benefit of these prior applications.

### FIELD OF THE INVENTION

The present invention relates to a wall element comprising two outer layers extending at least substantially parallel to each other, between which at least two intermediate layers are provided, wherein each intermediate layer extends between the outer layers in a zigzag fashion. The invention also relates to a method for manufacturing said wall element.

### BACKGROUND OF THE INVENTION

A wall element is described in the present Applicant's U.S. patent application Ser. No. 10/923,174 (publication no. US 2005-0074587) filed Aug. 20, 2004, entitled “Wall Element,” the contents of which are incorporated by reference into this application as if set forth verbatim. To form said wall element, two wall element halves (see FIG. 13 thereof) are first made, wherein each half consists of one outer layer and one zigzag-shaped intermediate layer connected thereto and wherein first parts of the intermediate layer that face towards the outer layer being connected to said outer layer. Then the two halves are joined together (see FIG. 14 thereof).

### SUMMARY OF THE INVENTION

The object of the invention is to improve the wall element that is known from the aforesaid U.S. patent application Ser. No. 10/923,174, in the sense that a wall element exhibiting an optimum constructional stiffness is provided for use as a structural element of a building, as a wall panel, for example in a partition wall, etc., while leaving out the time-consuming and labour-intensive step of first joining two wall element halves together. Incidentally it is noted that the term “wall element” is understood to include an element for a wall, a floor, a ceiling, a roof, etc.

In order to accomplish that objective, a wall element of the kind referred to above is according to the invention characterized in that said intermediate layers are identical in shape, with the intermediate layers being connected along their adjoining second parts. Research has shown that the present zigzag shape, in which the intermediate layers are connected along their adjoining second parts, results in an unexpectedly great constructional stiffness of the wall element, so that the wall element can be exposed to large forces without its shape stability being affected. The invention makes it possible to join the intermediate layers together first into an independent semi-finished product and subsequently provide the outer layers to form the final wall element. In principle the present wall element may be made of any material, for example aluminum, but it is in particular made of a cellulose material.

The intermediate layers are preferably nested, fitting together like plastic coffee cups, as it were. Typically, the facing first parts of the adjoining intermediate layers define a space between them, which means that they are spaced apart.

In a preferred embodiment of a wall element according to the invention, the intermediate layers are glued together along their adjoining second parts. Said gluing in particular takes place along glue lines that have been applied to said adjoining second parts beforehand.

In another preferred embodiment of a wall element according to the invention, the first and the second parts of each intermediate layer are at least substantially flat. As a result, an optimum bonding surface is created, which additionally enhances the structural integrity of the wall element.

In another preferred embodiment of a wall element according to the invention, each intermediate layer is at least substantially made of a material selected from the group consisting of corrugated cardboard, solid cardboard and wood. Preferably, each outer layers is likewise at least substantially made of a material selected from the group of corrugated cardboard, solid cardboard and wood. The intermediate layers and/or the outer layers are in particular made of corrugated cardboard whose corrugations extend in a zigzag fashion along the surface thereof, so that deformation of the intermediate layers and/or the outer layers in random directions along the surface will hardly be possible, if at all. In another preferred variant, each intermediate layer is at least substantially made of a material selected from the group consisting of metal and plastic. If a metal is selected, said metal will in particular be aluminum or steel. Preferably, the outer layers are likewise made of a metal, such as aluminum or steel.

It is preferable to form the intermediate layers from layers of paper/cardboard, each layer at least substantially being built up of a corrugated sublayer and a flat sublayer affixed to one side thereof, with the paper/cardboard layers being interconnected by means of an adhesive, in particular a glue, which is present on the ridges of the corrugated sublayers. In a special embodiment, said intermediate layers may also be made up of a corrugated sublayer, which is provided with a flat sublayer on either side thereof, with the two flat sublayers and the corrugated sublayer present therebetween being interconnected by means of an adhesive, in particular a glue present on the ridges of said corrugated sublayer. In a preferred variant, the outer layers are likewise formed from layers of paper/cardboard, each layer comprising a corrugated sublayer and a flat sublayer present on one side thereof, wherein the bond between the paper/cardboard layers is effected by means of an adhesive that is present on the ridges of the corrugated sublayers. In another preferred variant, the outer layers are made of wood. In yet another preferred variant, the outer layers are each made up of a gypsum board, which is built up of two paper/cardboard external layers, between which an internal gypsum layer is present. Said gypsum board may be connected to the intermediate layer of the present wall element either directly or with the interposition of a paper/cardboard layer.

It is noted that the term “paper” is generally used to indicate lighter sorts of paper, whilst the term “cardboard” is frequently used for heavier grades of paper. Within the framework of the invention, no restriction as regards the sort of material is intended when using the terms paper or cardboard and weight.

In another preferred embodiment of a wall element according to the invention, the wall element is arranged for accommodating pipes, cables and the like and/or insulation material and/or stiffening material in the intermediate layers thereof. The present wall element in itself provides an ideal thermal insulation on account of the relatively large air cavities that are present in the zigzag-shaped intermediate layer, but said cavities may also be used partially or entirely for drawing pipes, cables and tubes therethrough or for placing insulation and/or stiffening material therein.

The invention also relates to a method for manufacturing a wall element according to the invention, which method comprises the following steps to be carried out in succession:
first folding strips of a starting material into zigzag shapes along fold lines, each zigzag shape comprising first parts extending at least substantially parallel to outer layers yet to be provided, and second parts extending between adjacent first parts;
then joining the two zigzag shapes, which are identical in shape, together along their adjoining second parts; and
subsequently affixing the outer layers to the joined-together zigzag shapes on either side thereof.

In this way the joined-together intermediate layers are first formed as semi-finished products and subsequently provided with the outer layers on either side thereof.

In a preferred embodiment of a wall element according to the invention, the zigzag shapes are glued together.

In another preferred embodiment of a wall element according to the invention, the folds lines are in the form of score lines.

### BRIEF DESCRIPTION OF THE DRAWINGS

The invention will now be explained in more detail with reference to figures illustrated in a drawing, in which:

FIG. 1 is a schematic, perspective view of a preferred variant of a wall element according to the invention; and

FIG. 2 is a schematic, longitudinal sectional view of the wall element of FIG. 1.

### DETAILED DESCRIPTION

Exemplary embodiments of the invention are described in detail below with reference to the appended figures. The figures are not necessarily drawn to scale and do not necessarily show every detail or structure of the various embodiments of the invention, but rather illustrate exemplary embodiments and mechanical features in order to provide an enabling description of such embodiments.

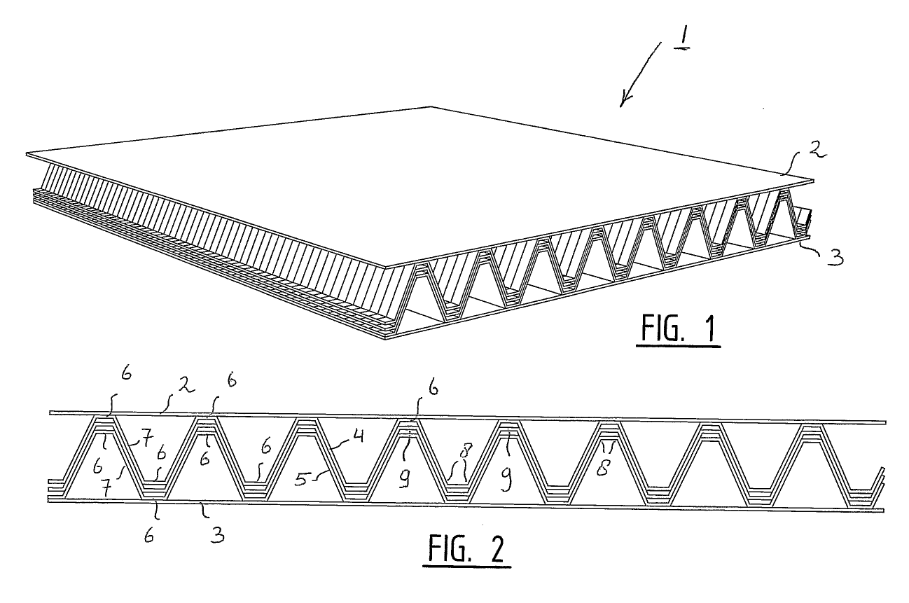

FIG. 1 shows a wall element (1) entirely made of corrugated cardboard, which consists of two mutually parallel outer layers (2,3) and three intermediate layers (4,5,9), which extend in a zigzag fashion between said outer layers (2,3). As FIG. 2 shows, each intermediate layer (4,5,9) comprises first parts (6) extending parallel to the outer layers (2,3), as well as second parts (7) extending obliquely between adjacent first parts (6). As far as the outer intermediate layers (4,5) are concerned, first parts (6) of the intermediate layer (4) that face towards the outer layer (2) are glued to said outer layer (2), whilst first parts (6) of the intermediate layer (5) that face towards the outer layer (3) are locally glued to said outer layer (3). All the intermediate layers (4,5,9) are identical in shape, being nested, as is illustrated in FIGS. 1 and 2. All the intermediate layers (4,5,9) are fitted together in the illustrated manner, like plastic coffee cups, as it were, with the intermediate layers (4,5,9) being glued together along their adjoining second parts (7). Glue lines are to that end applied to the adjoining parts (7).

As already noted before, each zigzag-shaped intermediate layer (4,5,9) is formed from a strip of starting material consisting of corrugated cardboard, which strip is folded into the zigzag shape along fold lines (8) in the form of score lines. The outer layers (2,3) are flat layers made of corrugated cardboard.

It is noted that the invention is not limited to the embodiment as shown herein, but that it also extends to other variants that fall within the scope of the appended claims. For example, it should be noted that steps recited in any method claims below do not necessarily need to be performed in the order they are recited. For example, in certain embodiments, steps may be performed simultaneously. The accompanying claims should be constructed with these principles in mind.

Any element in a claim that does not explicitly state “means for” performing a specified function or “step for” performing a specified function is not to be interpreted as a “means” or “step” clause as specified in 35 U.S.C. § 112, ¶6.

What is claimed is:

1. A wall element comprising first and second outer layers extending at least substantially parallel to each other, between which at least first and second intermediate layers are provided, wherein each intermediate layer extends between the outer layers in a zigzag fashion, each intermediate layer comprising first parts that extend at least substantially parallel to the outer layers and second parts that extend between adjacent first parts, wherein first parts of the first intermediate layer that face towards the first outer layer are connected to said first outer layer, and wherein first parts of the second intermediate layer that face towards the second outer layer are connected to said second outer layer, wherein said first and second intermediate layers are identical in shape, with the first and second intermediate layers being connected along their adjoining second parts, the facing first parts of the adjoining first and second intermediate layers thereby defining a space between them.

2. The wall element of claim 1, wherein the first and second intermediate layers are glued together along their adjoining second parts.

3. The wall element of claim 1, wherein the first and the second parts of each intermediate layer are at least substantially flat.

4. The wall element of claim 1, wherein each intermediate layer is at least substantially made of a material selected from the group consisting of corrugated cardboard, solid cardboard and wood.

5. The wall element of claim 1, wherein each outer layer is at least substantially made of a material selected from the group consisting of corrugated cardboard, solid cardboard and wood.

6. The wall element of claim 1, wherein the wall element is arranged for accommodating conduits.

7. The wall element of claim 6, wherein the wall element is arranged for accommodating pipes.

8. The wall element of claim 6, wherein the wall element is arranged for accommodating cables.

9. The wall element of claim 1, wherein the wall element is arranged for accommodating insulation material in the intermediate layers.

10. The wall element of claim 1, wherein the wall element is arranged for accommodating stiffening material in the intermediate layers.

11. A method of manufacturing a wall element, the method comprising:
folding strips of a starting material into zigzag shapes along fold lines, each zigzag shape comprising first parts extending at least substantially parallel to first and second outer layers yet to be provided, and second parts extending between adjacent first parts;
joining two zigzag shapes, which are identical in shape, together along their adjoining second parts, the facing first parts of the two adjoining zigzag shapes thereby defining a space between them; and
affixing the first and second outer layers to the joined-together zigzag shapes on either side thereof.

12. The method of claim 11, wherein said zigzag shapes are glued together.

13. The method of claim 11, wherein the fold lines are in the form of score lines.
